(19) United States
(12) Patent Application Publication
(10) Pub. No.: US 2011/0064524 A1
(43) Pub. Date: Mar. 17, 2011

(54) Diver operated jetting sled and method

(75) Inventor: Frank Hazen, Metairie, LA (US)

(73) Assignee: TRITON DIVING SERVICES LLC

(21) Appl. No.: 12/584,764

(22) Filed: Sep. 11, 2009

(51) Int. Cl. F16L 1/12

(52) U.S. Cl. 405/161

(57) ABSTRACT

A light weight self propelled jetting sled operable by a diver used to bury pipelines below the ocean floor with vertical jetting heads, horizontal jetting heads, bumpers, air lifts, buoyancy chambers, adjustable power rollers, upper rollers, water hand jet, and a control panel. In the method, with the use of buoyancy tanks and a jump sling, the diver can jump the jetting sled over crossing pipelines and continue the jetting operation without the need for surface cranes

The present invention relates to an underwater device and method for burying pipelines at the bottom of a body of water. More particularly, the present invention relates to a diver operated jetting sled used to bury pipelines below the ocean floor for cover from storms that may move the pipelines or shrimp nets or trawls that could snag and cause damage to the pipelines.

### BACKGROUND OF THE INVENTION

In the past jetting sleds or trenching machines were fabricated to bury pipelines down below the natural bottom of bodies of water such as the Gulf of Mexico and others. Some of these earlier jetting machines in the past were pulled by an air tugger or winch positioned on a barge or other vessel. Other large to medium size jetting machines were self propelled, being powered by a set of wheels powered by hydraulic motors and operated by a technician positioned on a barge or vessel. These larger jetting machines had to be installed over the pipeline with the use of a crane or an “A” frame and all were operated from the surface with the exception of very deep water jetting machines which were installed onto an ROV (Remote Operated Vehicle) but were also operated from the surface by an ROV pilot.

In those areas where there are numerous pipelines, it is inevitable that a new pipeline being buried by a jetting sled or trenching machine will cross an existing pipeline. This gives rise to a potentially hazardous situation in that the jetting sled or trenching machine could damage or rupture a buried pipeline crossing the path of the pipeline being installed. When such a device is remotely operated, the chances for a mishap increase because the operator does not have direct contact with the jetting sled or trenching machine. Any feed back to the operator, whether hydraulic or electronic may be too late to prevent an accident. Visual monitoring by TV may be obscured by silt.

### SUMMARY OF THE INVENTION

The present invention overcomes the inherent drawbacks of previous jetting sleds or trenching machines by providing a relatively small jetting sled, self propelled and manually operable by a diver positioned on a small platform at the rear of the jetting sled. The diver operates hydraulic levers to move the jetting sled forward and backward while a pipeline is being buried on the bottom of the ocean floor, thus insuring that no damage will occur to the pipelines and crossings in a congested field. Jetting water, compressed air and hydraulic power will be provided to the jetting sled from a surface vessel through a hose bundle.

In order to prevent damage to the pipeline being buried, the jetting sled will have guides just below driving rollers to help set the jetting sled over the pipeline.

The inventive jetting sled has buoyancy tanks mounted on each side for the purpose of floating/jumping crossings. As further noted below, the buoyancy tanks will assist the diver in jumping the jetting sled over an intersecting pipeline without the assistance of a crane. This is another feature that will save time and will eliminate the need to have a crane on a barge or other vessel pick up the jetting sled at each crossing in a field of multiple pipeline crossings.

At the front of the jetting sled is a jetting claw, comprising vertical rows of jetting heads on each side of the sled. The jetting claw, through the vertical jetting heads will produce a water spray of sufficient force to cut through the mud as the jetting sled moves forward, making a ditch as deep as the row of vertical jetting heads and as wide as the jetting sled. In a prototype of the inventive jetting sled, the row of vertical jetting heads is three foot high and the sled is three foot wide, thereby creating a ditch three foot deep by three foot wide.

In addition to the vertical jetting heads, the jetting sled also has horizontal rows of jetting heads on each side of the sled at the bottom of the sled running from front to back. The horizontal jets are used when the vertical jetting heads are turned off and are used to jet a hole for the sled when first placed in position over the pipeline. Once the sled is set, the horizontal jets are turned off and the front vertical jetting heads can be turned on for jetting in forward motion.

Behind the vertical jetting heads are two airlifts, one on each side of the jetting sled. Once the vertical jet heads break up the mud with the water spray, the airlifts will then suck up the broken mud from the bottom of the ditch and then deposit it outside of the ditch onto the natural bottom. In one prototype, the airlifts are approximately six inches in diameter and eight foot tall.

The jetting sled is self propelled by at least one set of opposed vertical rubber type rollers made in an hour glass configuration that move in toward the pipe by hydraulic rams from each side of the jetting sled so contact with the pipe can be made with a predetermined force. The rubber rollers are driven by hydraulic motors that will move the jetting sled both in forward and reverse motion relative to the longitudinal axis of the pipeline.

Once the rubber rollers make contact with the pipeline the diver will engage the motors to move the machine forward while the vertical jetting heads are jetting out water to break up the mud or sand bottom.

Installed between the air lifts of the jetting sled is a water hand jet with a length of jetting hose so the diver can clear mud from around pipeline crossings. In practical use, the length of the jetting hose should be between 30 to 50 feet and the hose should be approximately 2″ in diameter. The diver will operate the jetting sled along the pipeline until it comes to a pipeline crossing at which time he will stop the jetting sled's forward motion and reverse the jetting sled in a backward direction for approximately three feet. The diver at this time would remove the water hand jet installed on the sled and start hand jetting at the crossing and approximately 15 feet along the pipeline in the direction sled was moving before forward movement stopped. At this time the diver will install a “jump sling”, normally a 20′ by 2″ nylon strap attached from the middle of the jetting sled on to the pipeline approximately 10 feet from the crossing. Once the sling has been installed in place the diver will blow air into the buoyancy tanks to float the jetting sled above the pipeline and over the crossing. Once the sled has jumped the crossing and is directly over the pipe on opposite side of crossing, the diver will open the valves to flood the buoyancy tanks until the sled has been re-installed over the pipeline. Once the sling has been removed and hand jet has been secured the diver will once again start jetting the pipeline.

With diver operation, there is no danger of damage to pipeline crossings because with a diver operated sled as soon as contact is made with a crossing pipeline, the sled is stopped by the diver on board the jetting sled. Another advantage to the inventive jetting sled over others is that it can jump over crossings without the need of a crane. A crane is only needed for the first installation and the final removal. All crossings can be jumped by the jetting sled on it's own with no need for a crane.

A more detailed set of procedures for setting the jetting sled are as follows:

### Setting the Sled

Once the surface vessel such as a lift boat has arrived on location, one dive will be made to locate the pipeline and install (2) buoys 50′ apart on the pipeline and the diver return to surface.
The air and water valves on the jetting sled will be set in the correct position prior to lowering over the side.
The valves for the front jetting claw will be in the ¼ open position.
The valves for the bottom horizontal jets will be set in the full open position.
The air lift valves will be set in the full open position.
The sled will be secured to a crane by cables.
A ½″ line will be secured to the stern of the sled to be used as a down line for the diver.
The jet sled will be lifted off the deck of the lift boat and held out away from the vessel and lowered to within two feet of the water surface and stopped.
The jet pump will be engaged at this time to see that all jets on the bottom horizontal jetting bar and the front jetting claw are clear and working.
Once jets are checked the jet pump will be secured at the surface pump.
The jet sled will be lowered into the water until the air-lifts are one foot out of the water.
The surface compressor air valve will be turned on so the air lifts can be checked for proper operation.
Once air lifts are checked and are working, the air will be secured at the surface compressor.
The jet sled will be lowered in the water and positioned between the two pipeline buoys until sled is approximately three feet off bottom with all power secured to sled.
The diver at this time will enter the water while carrying with him a 30 foot piece of ¼″ line with a double knot 18″ from one end and descend down to the sled.
Once at the sled the diver will check that the hose bundle is not lying on the bottom or hung up on the sled and has a small amount of slack so there is no strain on the hose fittings.
The diver will orientate himself at the back of the sled and slide down to the bottom while holding onto the back of the sled.
Diver will secure the end of his 30 foot search line without the knot to the back of the sled. This knot will prevent the line from coming out of the divers hand as he is walking out to the end of his search line.
Once line is secured to sled he will back straight out from the jet sled.
Once at the end of the line he will make a sweep keeping his line tight going left to right until he locates the pipeline.
If pipeline isn't located then he will go back to the sled and have the crane start moving in the direction the pipeline is believed to be laying.
Once pipeline is located the diver will stop the crane and line the sled over the pipeline front and back and have the crane lower the sled to within one foot of the bottom.
The diver will back away from the sled to a safe distance while using his search line.
Once he is at a safe distance he will have topside start up the jet pump and come up on the pressure.
He will then have topside start up the air compressor and supply air to the airlifts.
The sled will hang one foot above the bottom for a short time as it starts jetting a hole to set in.
The jet sled will continue to be lowered slowly approximately two more feet while jetting and then all stop.
Once the sled has been lowered two feet and stopped, the air pressure and the jetting pressure will be secured at the surface.
Once jetting pressure and air pressure has been secured at the surface the diver will move back to the sled and check that the sled is still lined up on the pipeline and will set down square as it is lowered.
Once it is determined that the sled is lined up with the pipeline, the jet will be lowered very slowly as it is jetting until the sling on the crane is slack and the jet is setting squarely over the pipeline.
The jet and air will be secured and the diver will return back to the sled to check that the sled is on the pipeline and setting in a square position while touching with the horizontal jet sled rollers.
After the inspection is completed, the diver will have the hyd. pump started.
At this time the side rams with the vertical rollers will be moved in toward the pipeline until they make contact with the pipeline.
The diver will close the two horizontal bar jet valves located on top of the sled completely and then re-open these valves only ¼ open.
Diver will open the main vertical jet claw valve full open and check that the air lift valves are still in the full open position.
The diver will position himself on the operator's platform at the back of the sled making sure his hose is clear at all times.
Once the diver is in position he will ask topside to turn on the jet pressure and the airlifts.
The diver will stay on the operator's platform and let the jet continue jetting until he is able to feel forward movement when he engages the rollers and continue jetting forward.

A more detailed set of procedures for jetting and jumping a crossing pipeline are as follows:

### Jetting and Jumping a Crossing

As the jetting sled is jetting forward the diver will be alert for any sudden stops/bumps made by the jet sled.
If the sled does stop or bump an object, the diver will have the sled come to an all stop and will change the forward movement to reverse movement and have the sled back away from the object approximately three feet.
The diver will have the topside crew secure the air pressure, jetting pressure and hydraulic pressure.
The diver will dismount from the sled and go to the front of the sled to verify what made the sled stop.
If the object is debris the diver will remove this from the jetting area and get back on the sled and restore all pressure and continue jetting.
If the object is a crossing the diver will remove the hand jet from the sled and secure the vertical jet claw valves and the horizontal jet valve.
The hand jet valve will be open and the diver will move to the crossing with the hand jet and have topside come up on the jetting pressure to the hand jet when diver is at the crossing.
The diver will jet out the crossing and jet out a hole 3 feet deep the width of the sled for fifteen feet out from the crossing so the sled can be installed after jumping the crossing.
Once the hole is complete the diver will have topside secure the hand jetting pressure and return the hand jet back to the sled and secure the hand jet.
The diver will remove a 20′×2″ nylon strap from the sled and secure one end of strap to the pad-eye in the middle of the sled that is made for crossing jumping.
The other end of the strap will be run down and out through the front jetting claw of the sled and over the crossing to the pipeline on the other side of the crossing.
The strap will be secured to the pipeline 10 feet out away from the crossing with two wraps around the pipe and then shackle back to itself.
The strap will have three feet of slack left in the strap after it has been secured to the pipe so when it is floated, it will go up and as the sling starts to get tight it will move forward and up.
The diver will have the flotation valves set up for blowing water from the tanks.
Diver will take his down line and as topside gives him slack, he will walk out away from the sled to be in the clear.
The diver will have topside supply air to the flotation tanks slowly to start the sled moving.
As the sled is starting to move up the diver will be holding the down line that is still secured to the sled so he can feel as the sled is moving up and forward.
Once the sled has come to a stop and the strap is taut over the pipeline in the new position, the diver will go to the sled and climb back on the operator's platform and have topside secure the air as he secures the main air valve to the closed position on the sled.
The diver will slowly open the flood valves for flooding the tanks so the sled can be set back down over the pipeline.
Once back down on the pipeline, the diver will inspect that the sled is setting down square on the pipeline.
The nylon strap will be removed at this time and secured back on the sled and made fast.
The diver will climb back on operator's platform and have topside come up on hydraulic pressure.
The horizontal rams will be closed and the rollers pushed up against the pipeline.
The diver, at this time, will check that the rollers are in the correct position and the sled is setting square.
The diver will have topside come up on air and jetting pressure.
The sled will stay at this position for a short time before moving forward so it can jet out around the sled.
Once jet area is clean, sled will be put in forward motion and start jetting the pipeline again.

It is an object of this invention to provide a self propelled jetting sled for burying pipelines below the ocean floor having a front end, a rear end, a right side, a left side, and upper side and a lower side, comprising at least one set of vertical jetting heads mounted on the front end, at least one set of horizontal jetting heads mounted on the lower side, at least one set of bumpers mounted on the front end, at least one set of air lifts mounted on the right side and left side for removal of broken mud created by the vertical and horizontal jetting heads, at least two buoyancy chambers mounted on the right side and left side; at least one set of opposed power rollers driven by hydraulic motors, adjustably mounted on the right side and left side, a control panel mounted at the rear end and upper side for use by a diver, at least one unpowered roller for engagement with a pipeline, and a jetting hose and hand jet for use by the diver.

It is a further object of this invention to provide a method of jetting pipelines comprising the following steps:

Providing a light weight diver operated self propelled jetting sled comprising vertical jetting heads, horizontal jetting heads, bumpers, air lifts, buoyancy chambers, adjustable power rollers, upper rollers, water hand jet, and a control panel;

Lowering the diver operated self propelled jetting sled over a pipeline by a crane mounted on a barge or vessel at the surface of the body of water;

Turn on the horizontal jetting heads to jet a ditch allowing the jetting sled to fully straddle the pipeline with the upper rollers resting on the top of the pipeline;

Horizontally engage the power rollers by hydraulic ram devices and once engaged, turn off the horizontal jetting heads and turn on the vertical jetting heads and turn on the power rollers to begin movement along the pipeline;

If the bumpers come in contact with a crossing pipeline, stop the jetting sled's forward motion and reverse the jetting sled in a backward direction for approximately three feet.

Remove the water hand jet installed on the sled and start hand jetting at the crossing and approximately 15 feet along the pipeline in the direction sled was moving before forward movement stopped;

Installing a “jump sling” attached from the middle of the jetting sled on to the pipeline approximately 10 feet from the crossing and once sling has been installed in place blow air into the buoyancy tanks to float the jetting sled above the pipeline and over the crossing;

Once the sled has jumped the crossing and is directly over the pipe on opposite side of crossing, open the valves to flood the buoyancy tanks until the sled has been re-installed over the pipeline;

Remove sling and secure hand jet and again start jetting the pipeline.

### BRIEF DESCRIPTION OF THE DRAWINGS

FIG. 1 is a front perspective view of the inventive jetting sled.

FIG. 2 is a perspective view of the left side of the inventive jetting sled showing the device for retracting and engaging the left power roller.

FIG. 3 is a rear view of the jetting sled opening showing upper rollers and left and right power rollers.

### DETAILED DESCRIPTION OF THE INVENTION

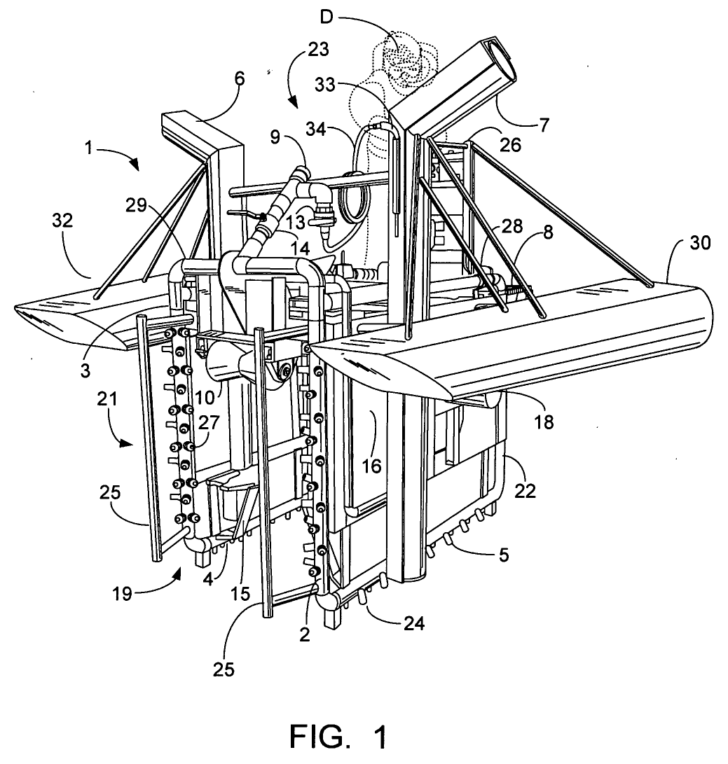

As depicted in FIG. 1, the inventive jetting sled 1 is meant to ride atop a pipeline, not shown, and jet a ditch below and around the pipeline while moving along the pipeline. A cross section of the jetting sled 1 would resemble an inverted “U”. The jetting sled 1 has a front end 19, a rear end 20, a left side 22, a right side 21, an upper side 23 and a bottom side 24. At the front end 19 can be seen one of the upper rollers 10 that would ride on the top of the pipeline. The guides 15 assist in placing the jetting sled 1 on the pipeline.

Also shown at the front end 19 are two vertical bumpers 25, one on the left side 22 and one on the right side 21. The bumpers 25 are meant to make contact with any intersecting or crossing pipelines and alert the diver operating the jetting sled to initiate crossing procedures.

As further depicted in FIG. 1, there is a left vertical jetting head 2 and a right vertical jetting head 3, as well as a right horizontal jetting head 4 and a left horizontal jetting head 5. Each jetting head comprises a multiplicity of nozzles 27 arrayed to expand the jetting function. Also shown is a right air lift 6 and a left air lift 7, with a left air lift line 16. The right air lift line is not shown. When the jetting heads are operating, the airlifts will suck up broken mud from the bottom of the ditch and deposit it outside of the ditch being jetted onto the natural bottom.

Pressurized water would be supplied from a surface vessel through a jetting water connection 9 into a jetting header 29. On this header 29 is shown a vertical jet valve 14, a horizontal jet valve 28, and a hand jet valve 13 connected to a jetting hose 34 and a jet 33, for the diver's use.

At the rear end 20 and the upper side 23 is shown a platform 8 for the diver along with a control panel 26.

The jetting sled 1 will have a right buoyancy chamber 32 and a left buoyancy chamber 30 with valve controls and compressed air supply from a surface vessel.

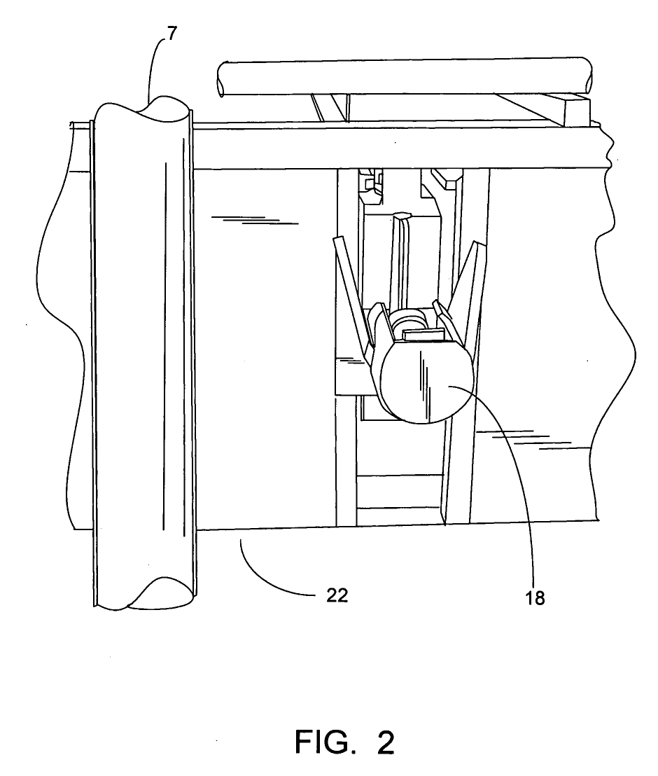

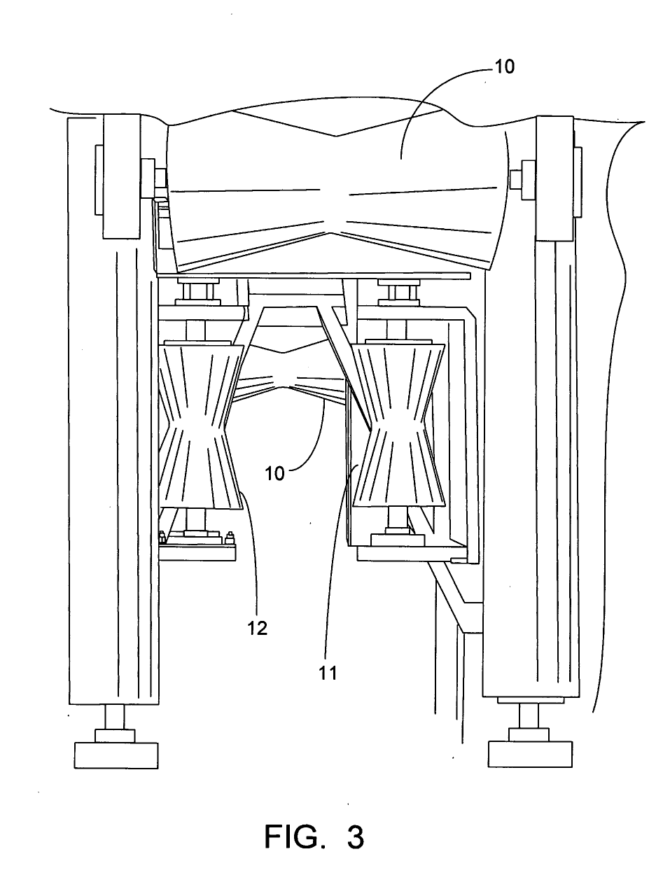

Referring first to FIG. 3, a view from the rear end 20 shows the upper rollers 10 at the rear end 20 and the front end 19. Below uppers rollers 10 are shown right power roller 11 and left power roller 12. While not shown, both power rollers 11 and 12 are each driven by a hydraulic motor. In addition each power roller 11 and 12 may be moved horizontally to engage or disengage the pipe. FIG. 2 depicts the device 18 used to engage and disengage the left power roller. The device 18 preferably would be a hydraulic ram or cylinder controlled at the control panel 26 by the diver.

For construction, the jetting sled 1 would preferably be manufactured from a lighter alloy such as aluminum to minimize the buoyancy requirements.

In practice, operation of the jetting sled would involve the following steps;

Providing a light weight diver operated self propelled jetting sled comprising vertical jetting heads, horizontal jetting heads, bumpers, air lifts, buoyancy chambers, adjustable power rollers, upper rollers, water hand jet, and a control panel;

Lowering the diver operated self propelled jetting sled over a pipeline by a crane mounted on a barge or vessel at the surface of the body of water;

Turn on the horizontal jetting heads to jet a ditch allowing the jetting sled to fully straddle the pipeline with the upper rollers resting on the top of the pipeline;

Horizontally engaging the power rollers by hydraulic ram devices and once engaged, turning off the horizontal jetting heads and turning on the vertical jetting heads and turn on the power rollers to begin movement along the pipeline;

If the bumpers come in contact with a crossing pipeline, stopping the jetting sled's forward motion and reversing the jetting sled in a backward direction for approximately three feet.

Remove the water hand jet installed on the sled and start hand jetting at the crossing and approximately 15 feet along the pipeline in the direction sled was moving before forward movement stopped;

Install a “jump sling” attached from the middle of the jetting sled on to the pipeline approximately 10 feet from the crossing and once sling has been installed in place blow air into the buoyancy tanks to float the jetting sled above the pipeline and over the crossing;

Once the sled has jumped the crossing and is directly over the pipe on opposite side of crossing, open the valves to flood the buoyancy tanks until the sled has been re-installed over the pipeline;

Remove sling and secure hand jet and again start jetting the pipeline.

I claim:

1. A self propelled jetting sled for burying pipelines below the ocean floor having a front end, a rear end, a right side, a left side, and upper side and a lower side, comprising at least one set of vertical jetting heads mounted on the front end, at least one set of horizontal jetting heads mounted on the lower side, at least one set of bumpers mounted on the front end, at least one set of air lifts mounted on the right side and left side for removal of broken mud created by the vertical and horizontal jetting heads, at least two buoyancy chambers mounted on the right side and left side; at least one set of opposed power rollers, adjustably mounted on the right side and left side, and a control panel mounted at the rear end and upper side for use by a diver.

2. The self propelled jetting sled of claim 1 further comprising at least one unpowered roller for engagement with a pipeline.

3. The self propelled jetting sled of claim 1 further comprising a jetting hose and hand jet for use by the diver.

4. The self propelled jetting sled of claim 2 further comprising a jetting hose and hand jet for use by the diver.

5. The self propelled jetting sled of claim 1 wherein each power roller further comprises a hydraulic motor.

6. The self propelled jetting sled of claim 2 wherein each power roller further comprises a hydraulic motor.

7. The self propelled jetting sled of claim 3 wherein each power roller further comprises a hydraulic motor.

8. The self propelled jetting sled of claim 1 manufactured of aluminum alloy.

9. A method of jetting pipelines comprising the following steps:
Providing a light weight diver operated self propelled jetting sled comprising vertical jetting heads, horizontal jetting heads, bumpers, air lifts, buoyancy chambers, adjustable power rollers, upper rollers, water hand jet, and a control panel;
Lowering the diver operated self propelled jetting sled over a pipeline by a crane mounted on a barge or vessel at the surface of the body of water;
Turning on the horizontal jetting heads to jet a ditch allowing the jetting sled to fully straddle the pipeline with the upper rollers resting on the top of the pipeline;
Horizontally engaging the power rollers by hydraulic ram devices and once engaged, turning off the horizontal jetting heads and turning on the vertical jetting heads and turning on the power rollers to begin movement along the pipeline;
Upon contact by the bumpers with a crossing pipeline, stopping the jetting sled's forward motion and reversing the jetting sled in a backward direction;
Removing the water hand jet installed on the sled and start hand jetting at the crossing along the pipeline in the direction sled was moving before forward movement stopped;
Installing a “jump sling” attached from the middle of the jetting sled on to the pipeline and once sling has been installed in place blowing air into the buoyancy tanks to float the jetting sled above the pipeline and over the crossing;
Once the sled has jumped the crossing and is directly over the pipe on opposite side of crossing, opening the valves to flood the buoyancy tanks until the sled has been re-installed over the pipeline;
Removing sling and secure hand jet and again start jetting the pipeline.
